(19) United States
(12) Patent Application Publication
(10) Pub. No.: US 2007/0213078 A1
(43) Pub. Date: Sep. 13, 2007

(54) WIRELESS COMMUNICATION METHOD AND SYSTEM FOR SUPPORTING MULTICAST BEARER SERVICES OVER AN IP MULTIMEDIA SUBSYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/618,024

(22) Filed: Dec. 29, 2006

Related U.S. Application Data
(60) Provisional application No. 60/763,792, filed on Jan. 31, 2006.

(51) Int. Cl. H04Q 7/20

(52) U.S. Cl. 455/466

(57) ABSTRACT

A wireless communication method and system for initiating the establishment, modification and termination of broadcast and multicast bearer services using an Internet protocol (IP) multimedia subsystem (IMS). The system includes an IMS domain, a multimedia broadcast/multicast services (MBMS) application server (AS) and a cellular network. The IMS domain includes an IMS AS, a media resource function control (MRFC) server and a media resource function processor (MRFP). A user equipment (UE) sends a session initiation protocol (SIP) INVITE message to the MRFC server via the cellular network, a proxy call state control function (P-CSCF) of the IMS AS and a serving call state control function (S-CSCF) of the IMS AS, for establishing an IMS-based MBMS session to the MBMS AS. If the UE is allowed to establish the IMS-based MBMS session, the UE receives multimedia support services to establish uplink and downlink connectivity to the MBMS AS.

### CROSS REFERENCE TO RELATED APPLICATIONS

This application claims the benefit of U.S. Provisional Application No. 60/763,792 filed Jan. 31, 2006, which is incorporated by reference as if fully set forth.

### FIELD OF INVENTION

The present invention is related to a wireless communication system. More particularly, the present invention is related to a method and system for using an Internet protocol (IP) multimedia subsystem (IMS) as a controlling mechanism to establish, modify and terminate multimedia broadcast/multicast services (MBMS) provided by the wireless communication system.

### BACKGROUND

The Third Generation Partnership Project (3GPP) requires enhancements to an IMS regarding support of media delivery of broadcast and multicast bearers. Multicast services are established via an IMS such that service providers are permitted to unify all multimedia services under the support of a session initiation protocol (SIP). Currently, MBMS and IMS-based services use independent applications with totally separate signaling protocols. Existing infrastructure can still support mechanisms that enhance delivery of multimedia to individual members of that group. An IMS server requests the multimedia to be sent to a group of IMS users.

Depending on the capabilities of the network, the IMS is capable of using an enhanced mechanism, (e.g., SIP for supporting multimedia broadcast/multicast services (MBMS)), for the delivery of multimedia to the group of IMS users. Traditional IMS services such as push-to-talk over cellular (PoC), conference, digital television, triple-play applications and multimedia, (i.e., video, audio and text), gaming can also be used. The advancement of IMS-based services, (e.g., PoC), can be extended to include the broadcast and multicast capabilities of MBMS. Using these multicast capabilities would minimize the number of independent control mechanisms for applications or services instances, ensure more efficient usage of radio resources and could circumvent the effect of multiple PoC users in the same area receiving the same talk burst with different delays.

MBMS ensures a resource and cost efficient data transfer to many users in parallel. IMS-based broadcast and multicast applications, such as sport events broadcasting/multicasting, emergency information, downloading, conversational multiparty conferencing, PoC and gaming, may be based on the existing multicast bearer service architecture to enhance their media delivery.

It would be desirable to combine the signaling protocols of MBMS and IMS-based services by using SIP as a control mechanism to establish, modify, terminate MBMS to a group of IMS users simultaneously in a unidirectional or multi-directional manner of communication.

### SUMMARY

The present invention is related to a wireless communication method and system for initiating the establishment, modification and termination of broadcast and multicast bearer services using an IMS. The system includes an IMS domain, a MBMS application server (AS) and a cellular network. The IMS domain includes an IMS AS, a media resource function control (MRFC) server and a media resource function processor (MRFP). A user equipment (UE) sends an SIP INVITE message to the MRFC server via the cellular network, a proxy call state control function (P-CSCF) of the IMS AS and a serving call state control function (S-CSCF) of the IMS AS, for establishing an IMS-based MBMS session to the MBMS AS. If the UE is allowed to establish the IMS-based MBMS session, the UE receives multimedia support services from the IMS-domain via the cellular network to establish uplink and downlink connectivity to the MBMS AS.

The present invention supports the establishment, modification and termination of broadcast and multicast bearer services using IMS, (i.e., SIP). When the UE sends the SIP INVITE message, a new broadcast or multicast session is established. Alternatively, the UE may be invited to join an existing session to an MBMS application server (AS), (i.e., a broadcast multicast service center (BM-SC)). In cooperation with the IMS AS, the MBMS AS sets up a unicast service for uplink and a multicast service for downlink for MBMS for the UE. Upon acceptance of the UE, the existing IMS AS, with the support of the MRCF server, establishes the necessary media resources, (e.g., codecs, ports, filters, policies, and the like), in a gateway general packet radio service (GPRS) support node (GGSN), and sends bearer information about the unicast bearer and the multicast bearer to the UE. The UE activates the unicast and the multicast bearers. This process is carried out once the IMS AS confirms that the UE is registered as IMS MBMS-capable. If the UE is not IMS MBMS-capable, the IMS AS sends a message to UE denying access to the MBMS AS via the IMS. A Legacy UE may still attempt to access the MBMS AS through conventional methods.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a block diagram of a system for supporting multicast bearer services using IMS in accordance with the present invention;

FIG. 2 is a signaling diagram of exemplary IMS conference use process in accordance with the present invention;

FIG. 3 is a signaling diagram of a process for conference joining in accordance with the present invention; and

FIG. 4 is a signaling diagram of a process for inviting a UE to a conference in accordance with the present invention.

### DETAILED DESCRIPTION OF THE PREFERRED EMBODIMENTS

When referred to hereafter, the terminology “user equipment (UE)” includes but is not limited to a wireless transmit/receive unit (WTRU), a mobile station, a fixed or mobile subscriber unit, a pager, a cellular telephone, a personal digital assistant (PDA), a computer, or any other user type of user device capable of operating in a wireless environment.

When referred to hereafter, the terminology “base station” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

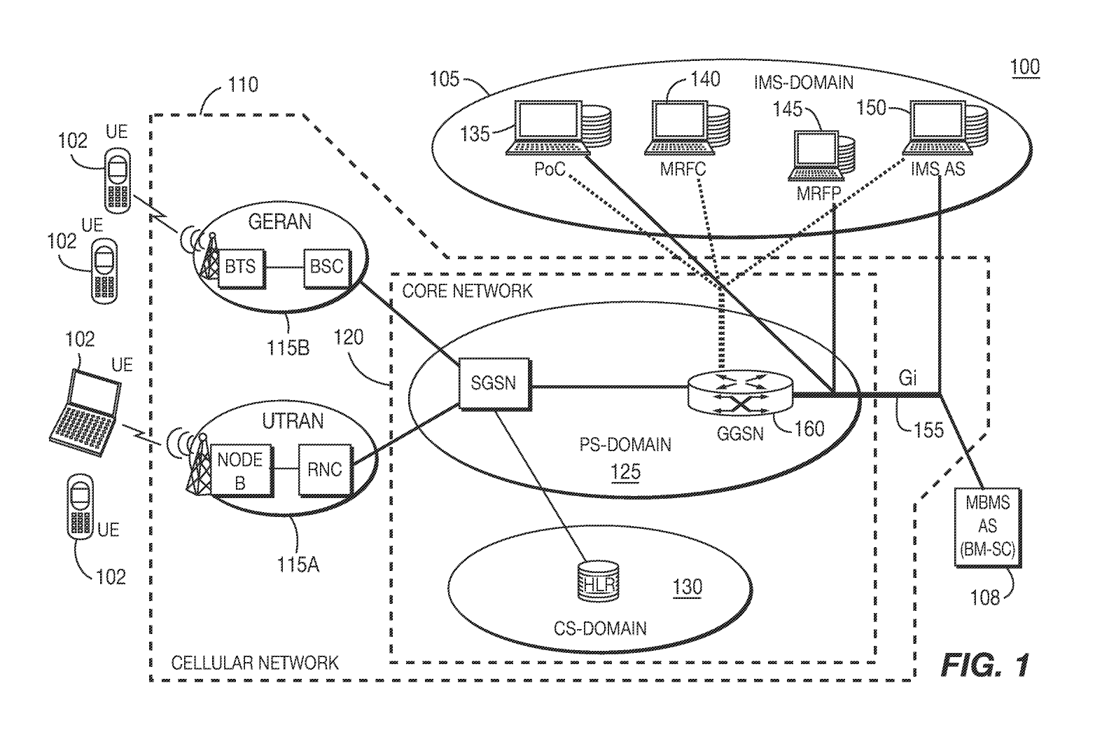

FIG. 1 is a block diagram of a wireless communication system 100 for supporting multicast bearer services using IMS in accordance with the present invention. The system 100 includes a plurality of UEs 102, an IMS-domain 105, an MBMS AS 108, (i.e., BM-SC), and a cellular network 110. The cellular network 110 includes a radio access network, (such as UMTS terrestrial radio access network (UTRAN) 115A or GSM EDGE radio access network (GERAN) 115B), and a core network 120. The core network 120 comprises a packet switch (PS) domain 125 and a circuit switch (CS) domain 130. The present invention may be applicable to any radio access network that has connectivity to IMS and MBMS services, such as 3GPP2, code division multiple access 2000 (CDMS2000), wireless local area network (WLAN), WiMAX, and the like.

In accordance with the present invention, a UE 102 receives multimedia support services from the IMS-domain 105 via the cellular network 110 to establish, modify and terminate uplink and downlink connectivity to the MBMS AS 108 for broadcast and/or multicast bearers. The IMS-domain 105 includes a PoC server 135, a media resource function control (MRFC) server 140, a media resource function processor (MRFP) 145 and an IMS AS 150.

The MRFC server 140 may perform the following tasks:
1) control the media stream resources in the MRFP 145;
2) interpret information coming from the MBMS AS 108 and a serving call state control function (S-CSCF), (e.g., session identifier) and control the MRFP 145 accordingly; and
3) generate charge data records (CDRs).

The MRFP 145 may perform the following tasks:
1) control of the bearer on the Mb reference point;
2) provide resources to be controlled by the MRFC server 140;
3) mix incoming media streams, (e.g., for multiple parties);
4) serve as a media stream source, (e.g., for multimedia announcements);
5) process the media stream, (e.g., audio transcoding, media analysis); and
6) control the “floor”, (i.e., manage access rights to shared resources in a conferencing environment).

The IMS AS 150 includes a P-CSCF and an S-CSCF, (not shown in FIG. 1). In a non-roaming case, the P-CSCF and the S-CSCF are located in the same network. In a roaming case, the visited network will provide access to the IMS services via a local P-CSCF, while the entire IMS AS 150 is located at the home network. The IMS AS 150 supports the PoC server 135 and conference servers, which manage members in a session by groups.

The present invention provides multicast media information check procedures and MBMS context activation and deactivation procedures for MBMS using IMS. The IMS AS 150 checks for session description protocol (SDP) information in response messages to determine whether the UEs 102 are MBMS-capable and whether they are ready for MBMS transmission. The IMS AS 150 also determines whether the requested media attributes requested by the UEs 102 are supported by the network and by the user service agreement. The IMS AS 150, upon acceptance of the services and according to the final agreement on the media resources between a UE 102 and the MBMS AS 108, triggers the execution of MBMS packet data protocol (PDP) context activation before the transmission, and deactivates MBMS PDP Contexts after the service is completed. A transmission function in the IMS AS 150 delivers a downlink media to a multicast group through a Gi interface 155. A security function may implement authentication and authorization functions based on the member information obtained via IMS signaling. The IMS AS 150 may authenticate UEs 102 by comparing credential information within a GGSN 160 in the PS-domain 125. An announcement function is necessary for the IMS AS 150 to ensure that a UE 102 is ready for MBMS sessions in IMS signaling.

The MBMS-AS 108 may perform the following tasks:
1) perform authorization and authentication of content providers;
2) verify integrity of data received from a content provider;
3) determine quality of service (QoS) for MBMS transmissions, (within operator configured QoS bounds), and MBMS data repetition and error resilient schemes to cope with possible transmission loss; and
4) charging a content provider.

Furthermore, the MBMS-AS 108 supports functions which allow a content provider to select from operator defined broadcast or multicast areas for MBMS, support several MBMS services taking into account their respective delivery constraints, and produce service announcements for the UE. The service announcement may include information about the required UE capabilities, schedule MBMS data transmission, and support one or more service providers

The interaction between the MRFC server 140 and the MRFP 145 will now be described. The MRFC server 140 may request the MRFP 145 to send tones to one, multiple or all parties connected in an IMS-based MBMS call/session with a given tone identifier for each specific tone. The MRFC server may request the tone to be played continuously until requested to be stopped, or may include in the request the length of time that the tone shall be played; the duration may be provisioned. The MRFC server 140 may request a notification from the MRFP 145 when the tone is completed. The MRFC server 140 may request that the MRFP 145 stops playing a tone.

The MRFC server 140 may request the MRFP 145 to play announcements referenced by pre-configured identifiers to one of several, multiple or all parties connected in an IMS-based MBMS call/session. The MRFC server 140 may request sequences of predefined fixed announcements within one request to the MRFP 145. The MRFC server 140 may request announcements to be played in a loop until it commands the MRFP 145 to stop. The MRFC server 140 may request the MRFP 145 to play an announcement for a fixed number of times. The MRFC server 140 may request the MRFP 145 to stop playing an announcement and to request the MRFP 145 to add some variants to the announcements, including date/day/month, time, digits, (i.e., the announcement may contain a number of digits to be controlled by the MRFC server 140—for example, a telephone number), money (currency), an integer, (i.e., a value within the announcement that is controlled by the MRFC server 140, (e.g., “you are caller number 3 in the queue”).

The MRFC server 140 may request the MRFP 145 to indicate when a specific announcement previously requested has been played successful, and the MRFP 145 may indicate error cases such as announcement not played successfully.

The MRFC server 140 may request the MRFP 145 to play multimedia to at least one party connected in an IMS-based MBMS call/session. The function of the playing multimedia is to play a synchronized audio and video media stream to the subscriber. The function can be used in services, such as a multimedia announcement, a multimedia mail box service, and the like.

The MRFP 145 may transcode an input codec into the session codec, if the multimedia file provides a different audio or video codec with the session codec. The MRFC server 140 may request the MRFP 145 to play multimedia in a loop until it commands the MRFP 145 to stop. The MRFC server 140 may request the MRFP 145 to play multimedia for a fixed number of times and to request the MRFP 145 to stop playing multimedia.

The MRFC server 140 may indicate to the MRFP 145 the multimedia file identifier and file format. The MRFC server 140 may request the MRFP 145 to indicate when a specific multimedia previously requested has been played successfully. The MRFP 145 may indicate error cases such as when multimedia is not played successfully.

The MRFP 145 may comprise a conference mixer and a floor control server. The MRFC server 140 may request the MRFP 145 to create resources for an IMS-based MBMS audio conference/session. The MRFC server 140 may indicate the maximum number of parties in the session. The MRFC server 140 creates resources for users to join an existing IMS-based MBMS session, and releases resources for users to leave an existing one. The MRFC server 140 may request the MRFP 145 to play tones or announcements, or record the audio during the conference. The different participants in an IMS-based MBMS audio session may use different audio codecs. The MRFC server 145 may indicate the floor control policy to the MRFP 145.

The MRFC server 140 may request the MRFP 145 to create resources for an IMS-based MBMS multimedia session. The MRFC server 140 may indicate the maximum number of parties in the IMS-based MBMS multimedia session. The MRFC server 140 may create resources for users to join an existing MBMS session, and to release resources for users to leave an existing session.

The MRFC server 140 may indicate to the MRFP 145 to play multimedia, or record the multimedia during the conference/session. The different participants may use different audio and or video codecs. The MRFC server 140 may indicate to the MRFP 145 to modify the media attribute, including creating a video stream or close the video stream, or modify the codec of audio or video. The MRFC server 140 may indicate to the MRFP 145 at least one of the following floor control policies:
1) floor control is in use or not;
2) the algorithm to be used in granting the floor;
3) the maximum number of users who can hold the floor at the same time;
4) to assign and modify the floor chair, if the floor is chair-controlled; and
5) the floor media type shall be audio, video or a combination thereof.

The MRFP 145 supports audio/video transcoding between streams of two terminations within the same context where the streams are encoded differently. The MRFP 145 supports the default 3GPP audio codec AMR (narrowband), and optionally any other audio codecs. The MRFP 145 also supports the default 3GPP video codec H.263, and optionally any other codecs.

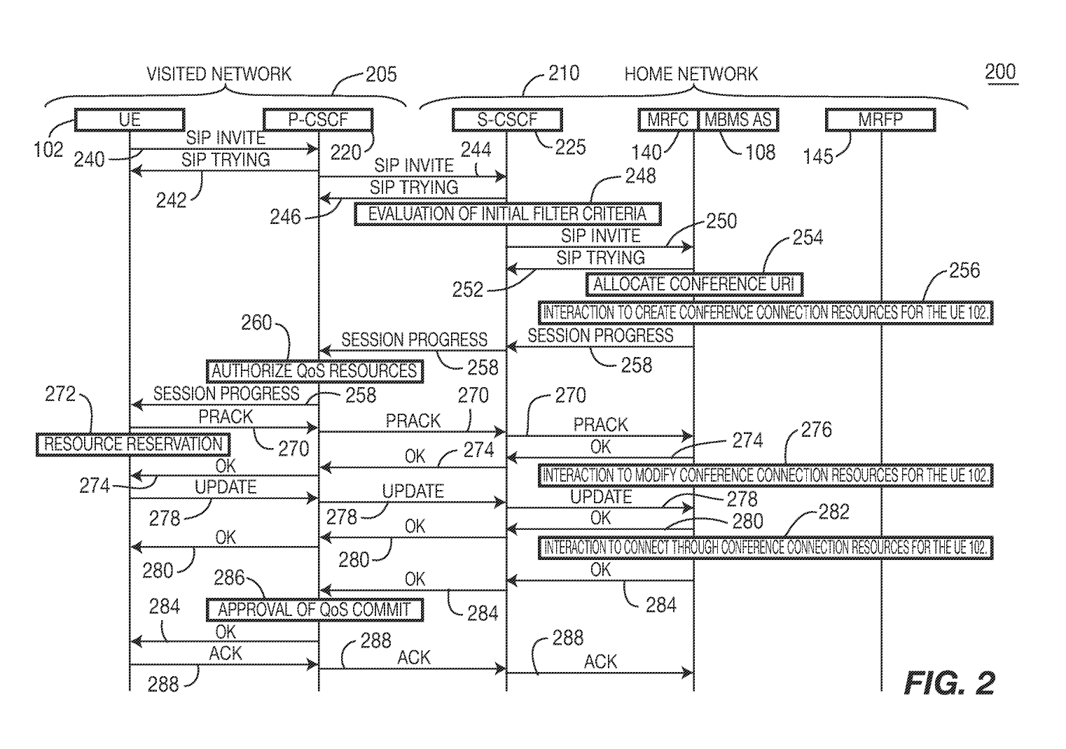

FIG. 2 is a signaling diagram of an exemplary IMS-based MBMS initiated service use process 200 in accordance with the present invention. A multimedia IMS-based MBMS session is set up for an enterprise meeting. Employees from different groups join the conference some via IMS-based conferencing UE, some via Legacy MBMS-capable UEs and some via IMS MBMS capable UEs. The present invention provides enhancements to prior art which provide multiparty conferencing using IMS separated from the MBMS Legacy system which requires it own independent signaling and controlling mechanism. The IMS-based MBMS combines both services using SIP as control signaling protocol for service establishment, modification, and termination. The present invention introduces SIP as control signaling protocol to join, start and end MBMS sessions.

IMS-based conferencing and MBMS services are combined in accordance with the present invention. The present invention utilizes existing IMS infrastructure, procedures, and methodologies to allocate and manage resources for the requested MBMS services. It also allows the combination of conferencing using multiple combination of infrastructures, (i.e., IMS-based conferencing, and MBMS), which allows the flexibility to variations of UEs with different capabilities to connect to IMS and MBMS-based services.

The process is the same in roaming and non-roaming scenarios. However, a non-roaming scenario is shown in FIG. 2 to illustrate the relationship between a visited network 205 and a home network 210. In a roaming UE scenario, the process is implemented in the visited network 205 where a P-CSCF 220 is allocated to support IMS applications for the UE 102 while the service is provided from the home network 210 where the IMS AS 150 is located. The visited network 205 includes at least one UE 102 and the P-CSCF 220. The home network 210 includes a serving call state control function (S-CSCF) 225 as part of the IMS AS 150, an MRFC server 140/MBMS AS 108 and an MRFP 145.

In step 240, the UE 102 sends an SIP INVITE message to the P-CSCF 220. The SIP INVITE message indicates that the UE 102 wants to establish an MBMS session and contains all necessary information, (e.g., codec information, bit rate, IP version IPv4 or IPv6, and the like), to do so. The P-CSCF 220 responds to the UE 102 with an SIP TRYING message (step 242) and forwards the SIP INVITE message to the S-CSCF 225 (step 244). The S-CSCF 225 responds with an SIP TRYING message (step 246) and may invoke service control logic for the UE 102. In step 248, the S-CSCF 225 begins evaluating initial filter criteria procedures for initializing the allocation of resources for the requested media types, by examining the user policy and availability of the service attributes, (e.g., codec information, data rate, and the like). The S-CSCF 225 forwards the SIP INVITE message to the MRFC server 140/MBMS AS 108 (step 250). The MBMS AS 108 provides the traffic services and the MRFC server 140 provides the supporting resources for these services. The MRFC server 140/MBMS AS 108 acknowledges the SIP INVITE message with an SIP TRYING message (step 252) and allocates a conference uniform resource identifier (URI) (step 254).

Referring still to FIG. 2, the MRFC server 140 controls the MRFP 145 to set up one unicast bearer for the uplink media stream and one multicast bearer for the downlink stream to the UE 102 (step 256). The MRFC server 140 sends the UE 102 both the uplink and downlink media bearers information in IMS signaling, preferably included in a SDP body. The MRFP 145 starts the allocation of resources necessary for the MBMS session to be carried out and sends a session progress message to indicate that the session is in progress so that the timers do not expire, and to update the UE 102 with the status of the call (step 258). Based on operator policy, the P-CSCF 220 may authorize the quality of service (QoS) resources necessary for this session (step 260).

The UE 102 analyzes the addresses provided in IMS messages and activates multicast bearers according to the MBMS activation procedures. If the UE 102 is not MBMS-capable, and therefore fails to activate the MBMS bearer services, the UE 102 indicates the desired unicast media address information to the MRFC server 140 with a provisional response acknowledgement (PRACK) message to confirm the acceptance of the MBMS call back to the UE 102 (step 270) and the UE 102 reserves resources (step 272). If the UE 102 is MBMS-capable, the UE 102 sends the PRACK message to the MRFC server 140 with the media session parameters the UE 102 chooses for the conference, including the uplink address and the downlink address. If the PRACK message is accepted, the MRFC server 140 sends an OK message to the UE 102 (step 274). In step 276, the MRFC server 140/MBMS AS 108 checks the result of media negotiation and interacts with the MRFP 145 to create conference connection resources for the UE 102 in accordance with an application policy. Update messages are sent from the UE 102 when a user wants to upgrade/downgrade his services, join another group, or the like (step 278). Then, OK messages are sent from the MFRC server 140 to the UE 102 to indicate that changes made to the connectivity and/or services are accepted (step 280). After the successful establishment of the conference connection, an end-to-end connection is established to exchange the multimedia (step 282) and OK messages are sent from the MFRC server 140 to the UE 102 (step 284). In step 286, the P-CSCF 205 controls policy enforcement to obtain the approval to commit all the resources associated with QoS of the requested service. In step 288, a final positive acknowledgement (ACK) is sent from the UE 102 to the MRFC server 140 indicating that it is ready to receive the service.

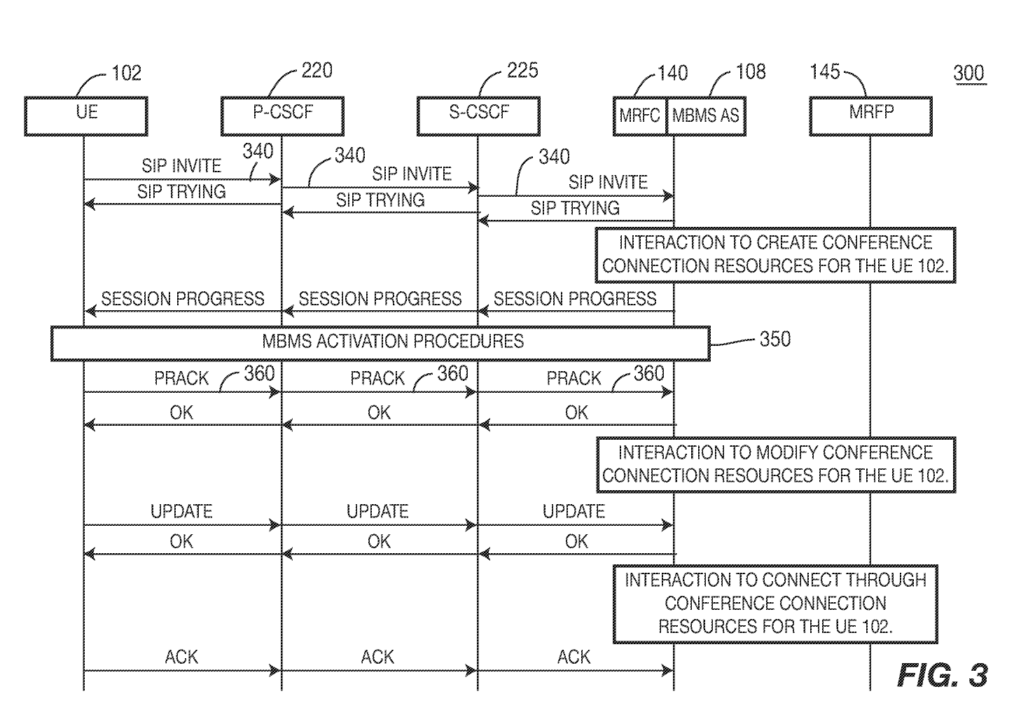

FIG. 3 is a signaling diagram of a process 300 for conference joining in accordance with the present invention. In step 340, the UE 102 sends a session initiation protocol (SIP) INVITE message to the MRFC server 140 for joining an on-going IMS conference. The MRFC server 140 controls the MRFP 145 to set up one unicast uplink bearer and one multicast downlink bearer. The MRFC server 140 provides the UE 102 with both the uplink and downlink media bearer information with IMS signaling, preferably included in an SDP body. The UE 102 examines the addresses provided in the IMS messages and activates multicast bearers according to MBMS activation procedures (step 350).

In the MBS activations procedures of step 350, an IMS session is initiated and an exchange of UE MBMS capability information occurs during or after the IMS session initiation. This information may include the capabilities of the UE 102, an MBMS support indicator and QoS parameters. The MBMS support indicator indicates whether MBMS is supported at the location where the UE 102 resides. The IMS AS 150 decides what bearer should be used for the IMS application based on information received during the MBMS capability exchange. In this case the IMS AS chooses an MBMS bearer for the IMS application. The IMS AS 150 communicates with the MBMS AS 108 for assignment of a unique multicast IP address/port and temporary mobile group identity (TMGI), and for the provisioning of other information related to the MBMS bearer service, (e.g., SDP parameters, QoS parameters and the like). Using MBMS bearer signaling, the information regarding the bearer decision of the IMS AS 150 is exchanged. In addition, QoS parameters are also exchanged. The IMS session is modified. MBMS bearer activation procedures and MBMS session start procedures are executed. The MBMS data transmission takes place a certain time after the MBMS session start procedures. When the session is terminated, IMS signaling is implemented for session tear-down and MBMS bearer deactivation procedures are implemented.

Referring to FIG. 3, if the UE 102 is not MBMS-capable and therefore fails to activate MBMS bearer services, the UE 102 indicates this to the MRFC server 140 with a PRACK message (step 360). If the UE 102 is MBMS-capable, the UE 102 joins the IMS conference using the one unicast uplink bearer and the one multicast downlink bearer.

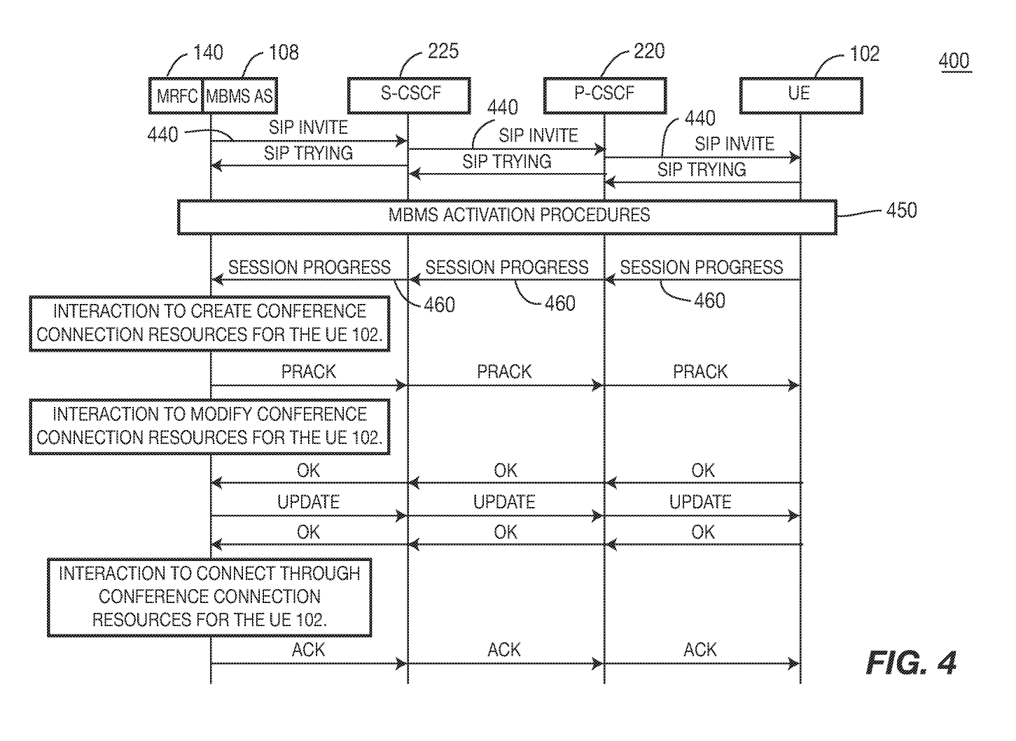

FIG. 4 is a signaling diagram of a process 400 for inviting a UE 102 to a conference in a terminated case in accordance with the present invention. When the MRFC server 140/MBMS AS 108 invites the UE 102 to a conference, one unicast uplink bearer and one multicast downlink bearer information is sent out to the UE 102 in an SIP INVITE message (step 440). The UE 102 receives the SIP INVITE message and analyzes the media information to activate multicast bearers according to the MBMS activation procedures (step 450). For an MBMS-capable UE, the MRFC server 140/MBMS AS 108 initiates setting up one unicast uplink bearer and one multicast downlink bearer for the UE 102 in accordance with the conference media information. If the UE 102 is not MBMS-capable and therefore fails to activate MBMS bearer services, the UE 102 may indicate this to the MRFC server 140 in a session progress message (step 460) and the MRFC server 140 decides whether or not to set up a unicast only session for the UE 102 based on the application policy. If the UE 102 is MBMS-capable, all IMS signaling messages should carry one unicast uplink bearer and one multicast downlink bearer information, preferably in SDP bodies.

Whether to manage both MBMS and non-MBMS UEs in one conference is decided in accordance with the policy of the AS 108. In accordance with one embodiment of the present invention, two different UEs 102 may be served by two parallel sessions of multicast and unicast. Alternatively, only MBMS-capable UEs are accepted in the multicast conference session and all non-MBMS UEs may be rejected.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including at least one user equipment (UE), an Internet protocol (IP) multimedia subsystem (IMS) domain, a multimedia broadcast/multicast services (MBMS) application server (AS) and a cellular network, the IMS domain including an IMS AS, a media resource function control (MRFC) server and a media resource function processor (MRFP), a method for initiating IMS-based MBMS comprising:
(a) the UE sends a session initiation protocol (SIP) message to the MRFC server, via the cellular network, a proxy call state control function (P-CSCF) of the IMS AS and a serving call state control function (S-CSCF) of the IMS AS, for establishing an IMS-based MBMS session to the MBMS AS;
(b) determining whether to allow the UE to establish the IMS-based MBMS session; and
(c) if the UE is allowed to establish the IMS-based MBMS session, the UE receiving multimedia support services from the IMS-domain via the cellular network to establish uplink and downlink connectivity to the MBMS AS.

2. The method of claim 1 further comprising:
the UE registering with the IMS AS as an IMS-MBMS-capable UE that is capable of supporting MBMS using IMS signaling.

3. The method of claim 1 further comprising:
the IMS AS instructing the MRFC server to establish the requested IMS-based MBMS session by contacting both the MBMS AS and the MRFP for setting up IMS-based MBMS bearers for the UE;
the MRFC server negotiating with both the MBMS AS and the UE regarding a set of MBMS multimedia bearer attributes by including information in a session description protocol (SDP) body of an SIP message sent to the MBMS AS and the UE;
the MRFC server, upon agreement on the set of the MBMS multimedia bearer attributes, instructing the MRFP to establish the necessary resources for supporting IMS-based MBMS in accordance with the agreement;
the IMS AS authorizing and allocating quality of service (QoS) resources for the IMS-based MBMS; and
the MRFC server indicating to the UE and the MBMS AS to start the IMS-based MBMS session.

4. The method of claim 3 further comprising:
the IMS AS checking for session description protocol (SDP) information in response messages received from the UE to determine whether the UE is MBMS-capable and whether the UE is ready for MBMS transmission.

5. The method of claim 3 further comprising:
the IMS AS determining whether requested media attributes requested by the UE are supported by the cellular network and the agreement.

6. The method of claim 3 further comprising:
the UE sending a message to the MRFC server which indicates that the UE failed to activate an MBMS bearer because the UE is not MBMS-capable.

7. The method of claim 1 further comprising:
the MRFC server sending the UE uplink and downlink media bearers information included in a session description protocol (SDP) body of an IMS message if the UE is allowed to establish the IMS-based MBMS session.

8. The method of claim 1 wherein the MBMS AS is a broadcast multicast service center (BM-SC).

9. The method of claim 1 wherein the UE is not allowed to establish the IMS-based MBMS session if the UE is not MBMS-capable.

10. The method of claim 1 further comprising:
if the UE is not MBMS-capable, and therefore fails to activate MBMS bearer services, the UE sending a provisional response acknowledgement (PRACK) message to the MRFC server which indicates desired unicast media address information.

11. A wireless communication system for initiating Internet protocol (IP) multimedia subsystem (IMS)-based multimedia broadcast/multicast services (MBMS) comprising:
(a) a cellular network;
(b) an MBMS application server (AS);
(c) an (IMS) domain comprising:
(c1) an IMS AS including a proxy call state control function (P-CSCF) and a serving call state control function (S-CSCF);
(c2) a media resource function control (MRFC) server; and
(c3) a media resource function processor (MRFP); and
a user equipment (UE) which sends a session initiation protocol (SIP) message to the MRFC server, via cellular network, the P-CSCF and the S-CSCF, for establishing an IMS-based MBMS session to the MBMS AS, whereby if the UE is allowed to establish the IMS-based MBMS session, the UE receives multimedia support services from the IMS-domain via the cellular network to establish uplink and downlink connectivity to the MBMS AS.

12. The system of claim 11 wherein the UE registers with the IMS AS as an IMS-MBMS-capable UE that is capable of supporting MBMS using IMS signaling.

13. The system of claim 11 wherein the IMS AS instructs the MRFC server to establish the requested IMS-based MBMS session by contacting both the MBMS AS and the MRFP for setting up IMS-based MBMS bearers for the UE.

14. The system of claim 13 wherein the MRFC server negotiates with both the MBMS AS and the UE regarding a set of MBMS multimedia bearer attributes by including information in a session description protocol (SDP) body of an SIP message sent to the MBMS AS and the UE.

15. The system of claim 14 wherein the MRFC server, upon agreement on the set of the MBMS multimedia bearer attributes, instructs the MRFP to establish the necessary resources for supporting IMS-based MBMS in accordance with the agreement.

16. The system of claim 15 wherein the IMS AS authorizes and allocates quality of service (QoS) resources for the IMS-based MBMS.

17. The system of claim 16 wherein the MRFC server indicates to the UE and the MBMS AS to start the IMS-based MBMS session.

18. The system of claim 17 wherein the IMS AS checks for session description protocol (SDP) information in response messages received from the UE to determine whether the UE is MBMS-capable and whether the UE is ready for MBMS transmission.

19. The system of claim 17 wherein the IMS AS determines whether requested media attributes requested by the UE are supported by the cellular network and the agreement.

20. The system of claim 17 wherein the UE sends a message to the MRFC server which indicates that the UE failed to activate an MBMS bearer because the UE is not MBMS-capable.

21. The system of claim 11 wherein the MRFC server sends the UE uplink and downlink media bearers information included in a session description protocol (SDP) body of an IMS message if the UE is allowed to establish the IMS-based MBMS session.

22. The system of claim 11 wherein the MBMS AS is a broadcast multicast service center (BM-SC).

23. The system of claim 11 wherein the cellular network comprises a core network including a gateway general packet radio service (GPRS) support node (GGSN) in which the IMS AS, with the support of the MRCF server, establishes the necessary media resources and sends bearer information about a unicast bearer and a multicast bearer to the UE.

24. The system of claim 11 wherein the UE is not allowed to establish the IMS-based MBMS session if the UE is not MBMS-capable.

25. The system of claim 11 wherein if the UE is not MBMS-capable, and therefore fails to activate MBMS bearer services, the UE sends a provisional response acknowledgement (PRACK) message to the MRFC server which indicates desired unicast media address information.

26. In a wireless communication system including at least one user equipment (UE), an Internet protocol (IP) multimedia subsystem (IMS) domain, a multimedia broadcast/multicast services (MBMS) application server (AS) and a cellular network, the IMS domain including an IMS AS, a media resource function control (MRFC) server and a media resource function processor (MRFP), a method for inviting a user equipment (UE) to join a conference comprising:
(a) the MRFC server sending a session initiation protocol (SIP) message to the UE via a serving call state control function (S-CSCF) of the IMS AS, a proxy call state control function (P-CSCF) of the IMS AS and the cellular network for establishing an IMS-based MBMS session to the MBMS AS;
(b) the UE receiving the SIP message and analyzing media information to activate multicast bearers according to MBMS activation procedures;
(c) determining whether to allow the UE to establish the IMS-based MBMS session; and
(d) if the UE is allowed to establish the IMS-based MBMS session, the UE receiving multimedia support services from the IMS-domain via the cellular network to establish uplink and downlink connectivity to the MBMS AS so that the UE can join an existing conference.
